(19) United States
(12) Patent Application Publication
(10) Pub. No.: US 2015/0276115 A1
(43) Pub. Date: Oct. 1, 2015

(54) METHOD OF INSTALLING AN EMERGENCY FLOW RESTRICTOR DEVICE (EFRD) ON A PIPELINE

(71) Applicant: Maverick Supervision Inc., Fort St. John (CA)

(72) Inventor: William BAKER, Fort St. John (CA)

(73) Assignee: Maverick Supervision Inc., Fort St. John (CA)

(21) Appl. No.: 14/250,631

(22) Filed: Apr. 11, 2014

(30) Foreign Application Priority Data
Apr. 1, 2014 (CA) 2847778

(51) Int. Cl. F16L 55/10

(52) U.S. Cl. CPC F16L 55/10

(57) ABSTRACT

There is described a method that will enable an Emergency Flow Restrictor Device (EFRD) to he installed on a pipeline, without stopping the flow of fluid through the pipeline.

### FIELD

There is described a method of installing an Emergency Flow Restrictor Device (EFRD) on a pipeline, without stopping the flow of fluid through the pipeline.

### BACKGROUND

Leaks from pipelines have caused environmental damage and much adverse publicity. The reaction from the pipeline companies and government regulators is to propose the installation of an Emergency Flow Restrictor Device (EFRD) at intervals along each pipeline. Through use of the EFRD, sections of pipeline can he isolated to limit the amount of leakage to a damaged section.

The installation of EFRD along existing pipelines is slowly progressing. The current method used to install an EFRD (Emergency Flow :Restrictor Device) valve is quite cumbersome as it requires a great deal of preparation work and expense. It also requires stopping the flow of the pipeline (called an outage) for about 24 hours (or installing a temporary bypass line and 2 more stopples). Without the bypass line it is very difficult to coordinate an outage date, often taking as much as a month. Even when an outage has been approved, there is the problem of meeting the installation deadline. The deadline is very strict (there is enormous money at stake) so the supervisor is forced to have everything he might need on site. Because so much extra equipment must be on site it requires a huge parking area (and because the pipelines cross mostly private land) it usually means placing an enormous amount of wooden mats to prevent soil damages. Of course the safety challenges of working crews around the clock, and under a tight timeline, are much greater as well. What is required is a method that will enable an EFRD to he installed without stopping the flow of fluid through the pipeline

### SUMMARY

There is provided a method of installing an Emergency Flow Restrictor Device (EFRD) on a pipeline. A first step involves providing a first face plate having two or more segments that, when assembled, circumscribe the pipeline and a second face plate having two or more segments that, when assembled, circumscribe the pipeline. A second step involves assembling and welding the first face plate in place encircling the pipeline and the second face plate encircling the pipeline, in face to face relation to the first face plate. A third step involves assembling a circular cutting wheel around the pipeline between the first face plate and the second face plate. A fourth step involves providing a valve body having two or more segments that, when assembled, enclose the pipeline, the first face plate, the second face plate and the cutting wheel, the valve body having an access opening. A fifth step involves assembling and welding the valve body in place around the pipeline, the first face plate, the second face plate and the cutting wheel, the valve body being capable of containing fluids at pipeline pressures. A sixth step involves installing an access valve on the access opening. the access valve having an open position and a closed position, objects can be passed through the access valve when in the open position. A seventh step involves securing a cutting tower to the access valve, moving the access valve to the open position and lowering a drive linkage from the cutting tower through the access valve to engage the cutting wheel. An eighth step involves driving the cutting wheel, by means of the drive linkage, to sever a section of the pipeline between the first face plate and the second face plate. A ninth step involves retracting the drive linkage into the cutting tower, pulling the cutting wheel and severed section of pipeline inside the cutting tower. A tenth step involves closing the access valve to enable the cutting tower to be removed. An eleventh step involves installing a control section of the EFRD (the bottom having a converter flange to change the configuration from round to rectangular) with the valve gate member and linkage to control the valve gate member. A twelfth step involves opening the access valve and lowering a valve gate member for the EFRD through the access valve and into position to close the EFRD valve when/if required.

The EFRD valve described above is a fully operational gate valve system that can be installed and ready to use without disrupting the flow of the pipeline. The installation is a simple process and saves a tremendous amount of time and money because it does not require an outage (shut down) of the pipeline. The method of installation is similar to a “hot tap” procedure, in the sense that it is welded onto the pipeline in 2-halves and uses a block valve as an access valve and a cutting tower during the procedure. The similarities end there however; as the face plates and cutting system are installed before the valve body is installed.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of a pipeline with a first face plate and a second face plate mounted in spaced relation.

FIG. 2 is a side elevation view of a cutting wheel.

FIG. 3 is a section view of the cutting wheel of FIG. 2, with gear detail,

FIG. 4 is an end elevation view of the cutting wheel of FIG. 2.

FIG. 5 is a side elevation view of cutting assembly for cutting wheel of FIG. 2.

FIG. 6 is an end elevation view of cutting assembly of FIG. 5.

FIG. 7 is a top plan view of bottom segment of valve body on pipeline.

FIG. 8a is an end elevation view, in section, of the valve body of FIG. 7.

FIG. 8b is a detailed end elevation view, in section, of the valve body of FIG. 7.

FIG. 9 is a side elevation view of valve body on pipeline.

FIG. 10 is an end view, in section, of valve body on pipeline.

FIG. 11 is a top plan view of valve body on pipeline.

FIG. 12 is an end elevation view, in section, of a drive assembly for the cutting wheel of FIG. 2.

FIG. 13 is an end elevation view, in section, of valve controller with gate valve member.

### DETAILED DESCRIPTION

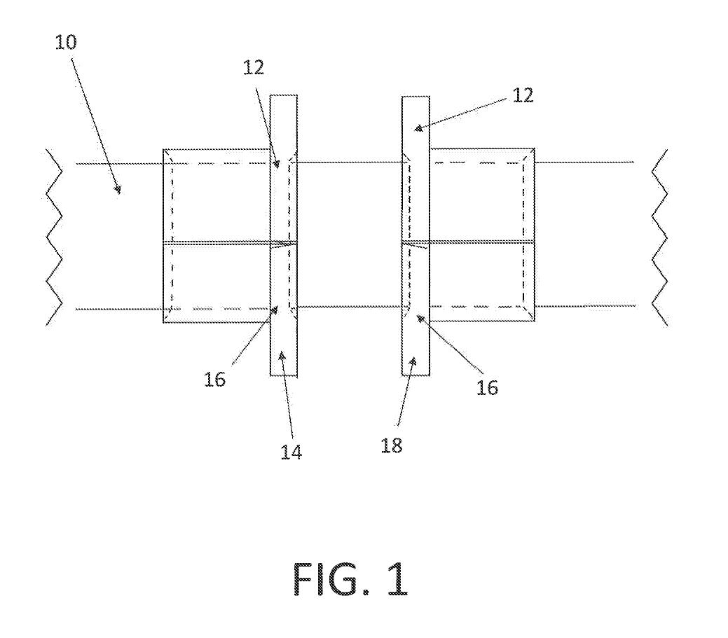

A method of installing an Emergency Flow Restrictor Device (EFRD) on a pipeline will now be described with reference to FIG. 1 through FIG. 13.

The following step by step installation instructions (and explanation of how each part works) break down the procedure.

Referring to FIG. 1, a pipeline is identified by reference numeral 10, clean and prepare the length of pipeline 10 required for the valve installation.

Referring to FIG. 1, place a first segment 12 of a 2-segment first face plate 14 on pipeline 10 and “tack” weld it into place.

Referring to FIG. 1, place a second segment 16 of first face plate 14 onto pipeline 10 and tack weld it to first segment 12 (insuring they are as square and true as possible).

Referring to FIG. 1, weld both first segment 12 and second segment 16 together and at both ends (taking care they don't warp or draw while welding). First segment 12 and second segment 16 of first face plate 14 are chamfered on the inside edges, and here they connect to each other, to provide room for the welds.

Referring to FIG. 1, install segments 12 and 16 of second face plate 18, using the same procedure. Second face plate 18 and first face plate 14 are in parallel spaced relation, Temporary spacers (not shown) may be used to insure the gap between first face plate 14 and second face plate 18 is precise. Remove any weld or slag from the surface of the face plates 14 and 18 (taking care not to scratch or score the surface of the plates).

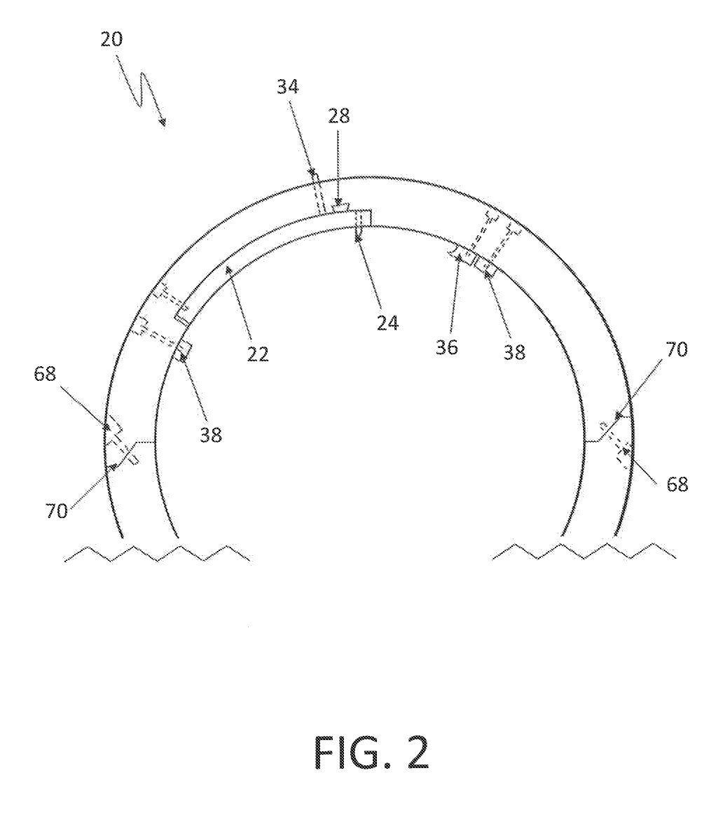

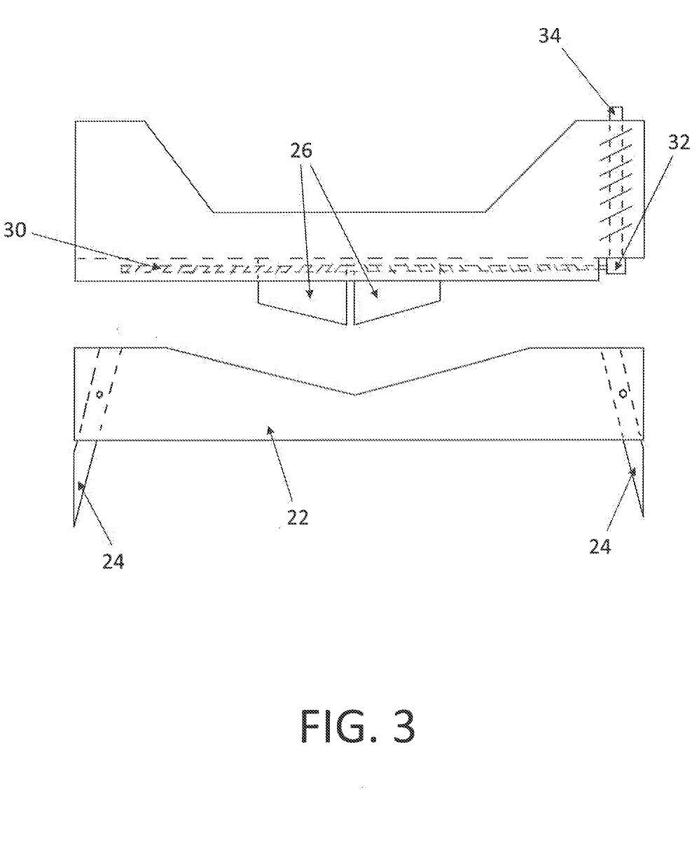

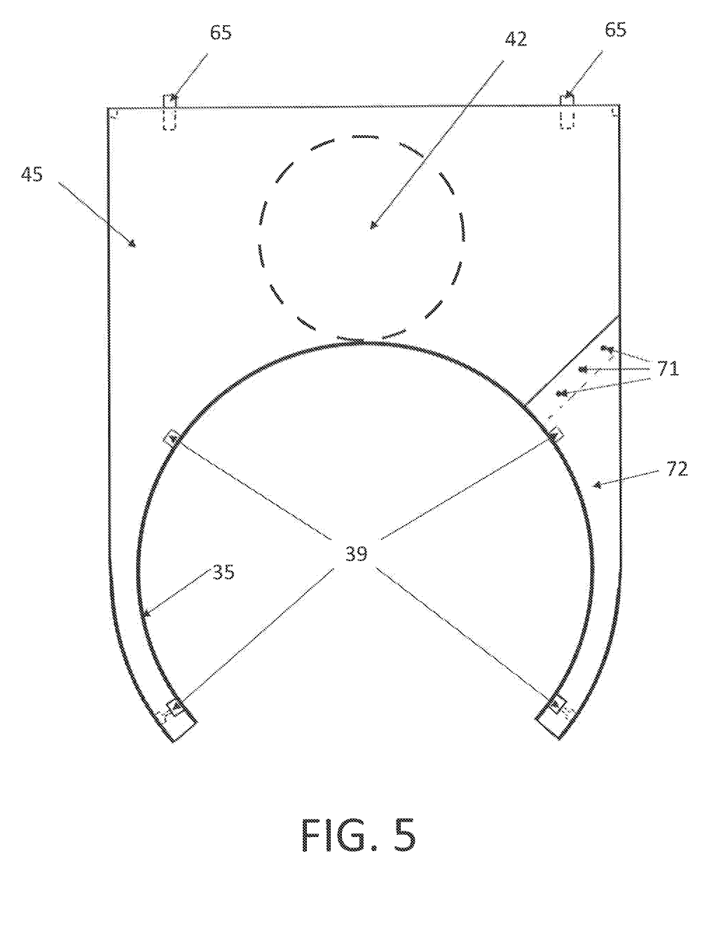

Referring to FIG. 2, set a 2-piece cutting wheel 20 into place and bolt it together using connecting bolts 68 in connecting points 70. Each half of cutting wheel 20 has a cutting bar 22 mounted on the inside. Referring to FIG. 3, each cutting bar 22 has 2 cutting bits 24 (one on each side). Each cutting bar 22 is activated by 2-wedges 26 that slide in tapered slots 28 on the inside of cutting wheel 20. A worm-screw 30 (with a left hand thread on one end and a right hand thread on the other) is threaded through these wedges 26. A “spring loaded” ratchet 32 is fastened to one end of worm-screw 30. A “spring-loaded” plunger 34 runs through the edge of cutting wheel 20, which contacts a striker plate 35 (shown in FIG. 5) when cutting wheel 20 rotates, pushing ratchet 32 down each time plunger 34 is depressed. This turns the worm-screw 30 which moves wedges 26 apart, moving cutting bits 24 down at the precise rate required (like a machine lathe) to sever the section of pipeline 10. In order to prevent damage to the worm screw 30, spring loaded latches are preferably provided (not shown). When the wedges 26 reach a “full-cut” position they trigger the latches, which act to contain the ratchet 32 in the down position and prevent further movement of the worm screw 30 should the cutting wheel 20 be operated longer than is required to complete the cutting of the pipeline 10.

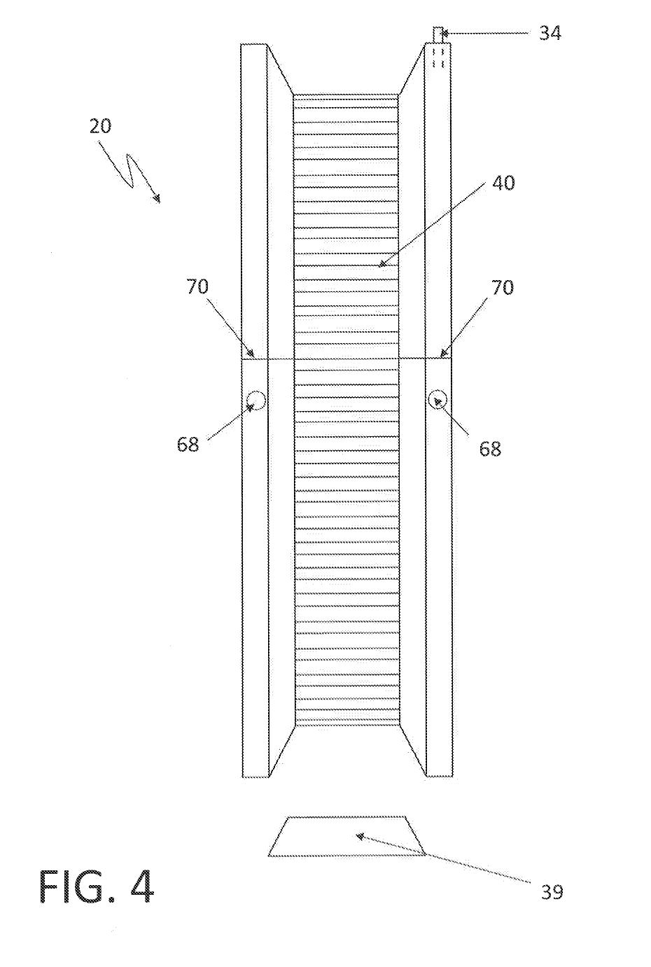

Referring to FIG. 2, a rubber and magnetic “catcher” 36 sits behind each set of cutting bits 24 (to contain the metal cuttings inside the cutting wheel). Referring to FIG. 5, four Teflon™ alignment guides 38 are mounted on the inside of cutting wheel 20, to insure it runs true with pipeline 10 while turning. Referring to FIG. 4 and FIG. 5, the outside of cutting wheel 20 (centre section) is a driven gear 40, which engages a drive gear 42, which rotates the wheel 20 during the cut procedure. Referring to FIG. 4, on either side of this driven gear 40 cutting wheel 20 is sloped so a second set of Teflon™ guides 39 in the drive assembly hold it straight and true and in contact with drive gear 42. The outer edges of cutting wheel 20 provide room for connecting bolts 68 that are received in connecting points 70 and plungers 34 that operate the cutting bars 22 (as the drive assembly is only the width of the Teflon™ guides 39). Providing two sets of Teflon™ guides 38 and 39 serves to provide control over the cutting wheel 20. The first set of alignment guides 38 are provided such that they are aligned with the outside of the cutting wheel 20, ensuring the cutting wheel 20 remains aligned and securely in contact with the driving gear 42 during the cutting process. The second set of alignment guides 39 fit within the inside of the cutting wheel 20, ensuring that the cutting wheel 20 runs true and minimizing chatter and vibration during the cutting process.

Referring to FIG. 5, remove a section 72 from the first portion of the drive assembly 45 using connecting bolts 71, and slip the assembly 45 into place (over top of the cutting wheel 20). Reinstall the section 72 of drive assembly and adjust the Teflon™ guides 39.

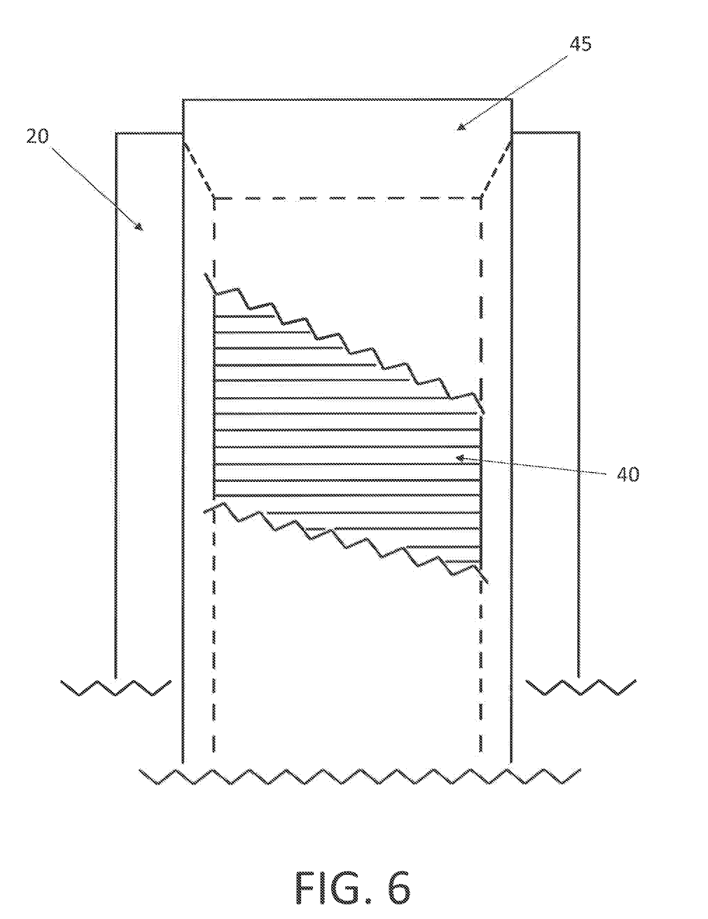

Referring to FIG. 6, the exterior of first portion of the drive assembly 45 is shown engaging cutting wheel 20. The outside edges of cutting wheel 20 are spaced such that the drive assembly 45 fits within the edges. The cut away in FIG. 6 shows the driven gear 40 that engages with drive assembly 45.

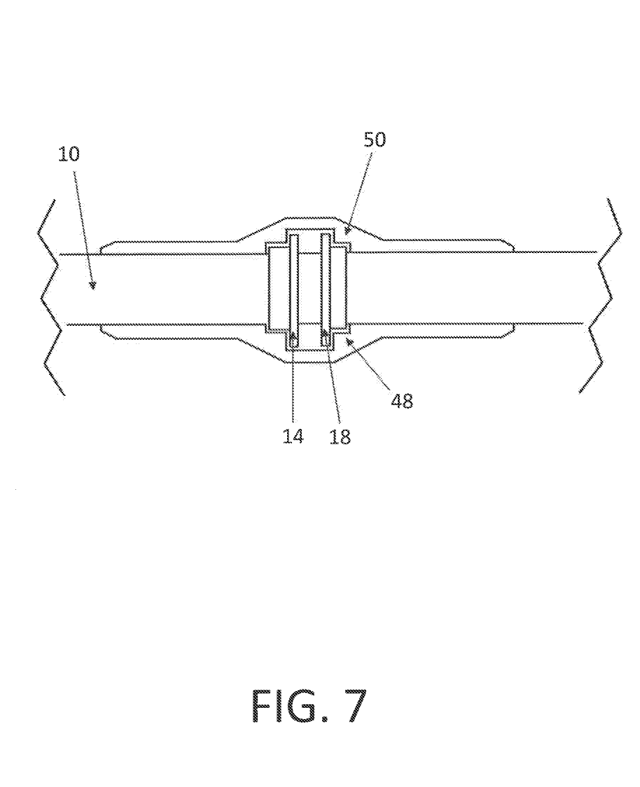

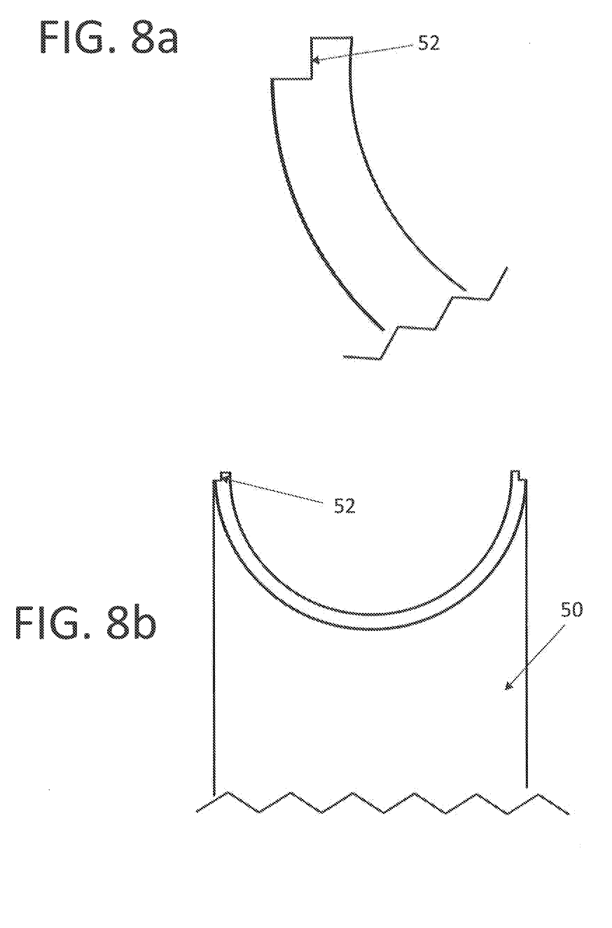

Referring to FIG. 7, lift lower half 48 of valve body 50 into place, and tack weld it (insuring it is level). Referring to FIG. 8a and FIG. 8b, the “centre section” of valve body 50 has a lip 52 for the top half of valve body 50 to slip down over (to insure the two halves can be welded together without any weld entering the “working portion” of the valve),

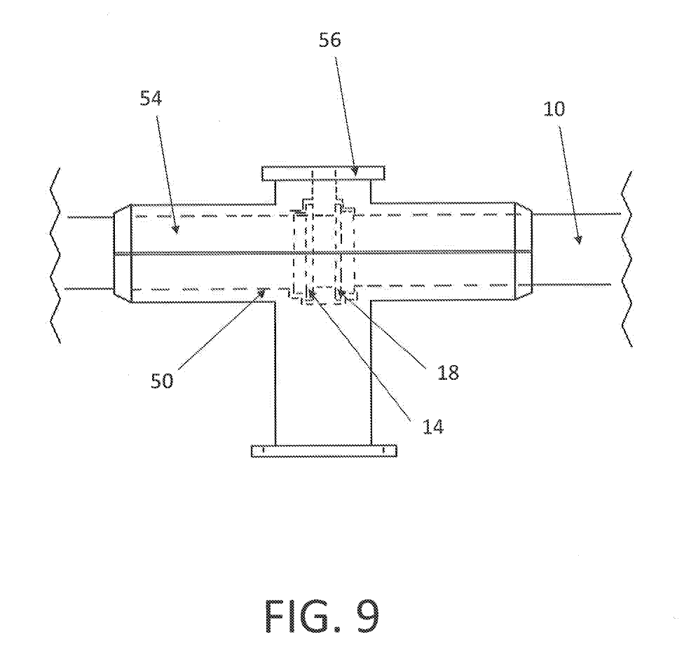

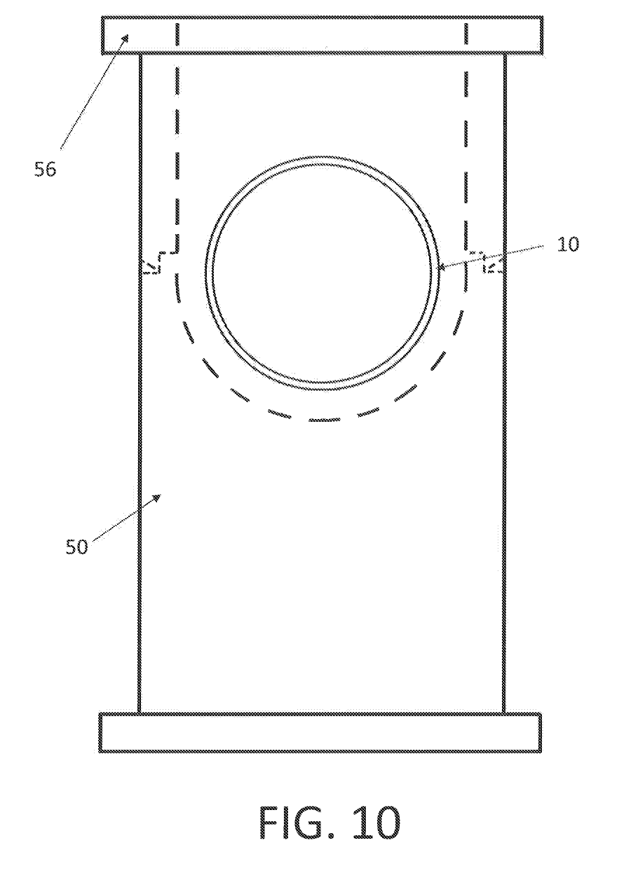

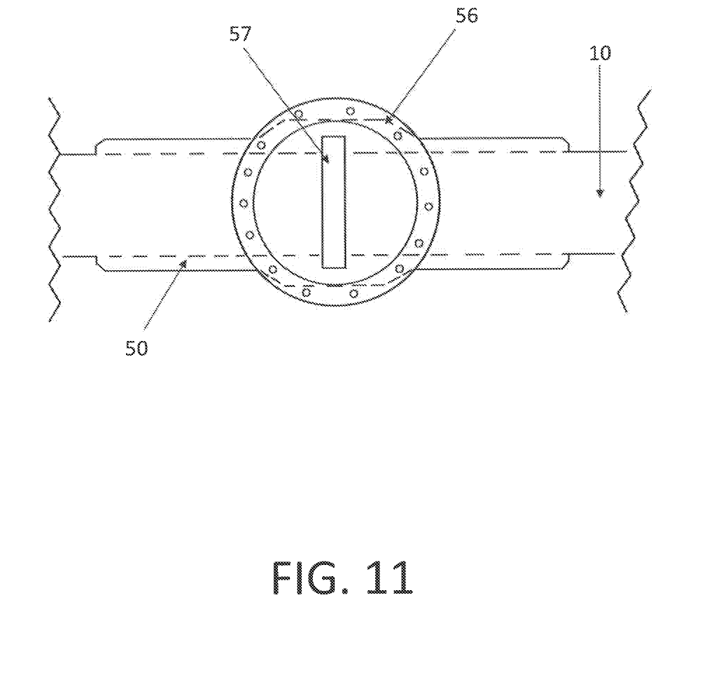

Referring to FIG. 9, top half 54 of valve body 50 is now set into place and both halves are welded together, and onto pipeline 10 (the cutting assembly sticking up through the slot in the top, but just below the level of the flange). Referring to FIG. 10 and FIG. 11, valve body 50 has a flange 56 defining an access opening 57. Please note: Because a gate valve member for an EFRD valve is wider than pipeline 10, the flange would be constructed to fit a larger size pipe (IE; a 24″ pipeline will require a 30″ flange).

It is preferred a blind flange (not shown) is now installed and EFRD valve body 50 is pressure tested. The blind flange may be made in any way known in the art. For example, the blind flange may be a flat plate that is bolted onto flange 56 such that valve body 50 can be pressure tested. When the test is completed this blind flange is removed.

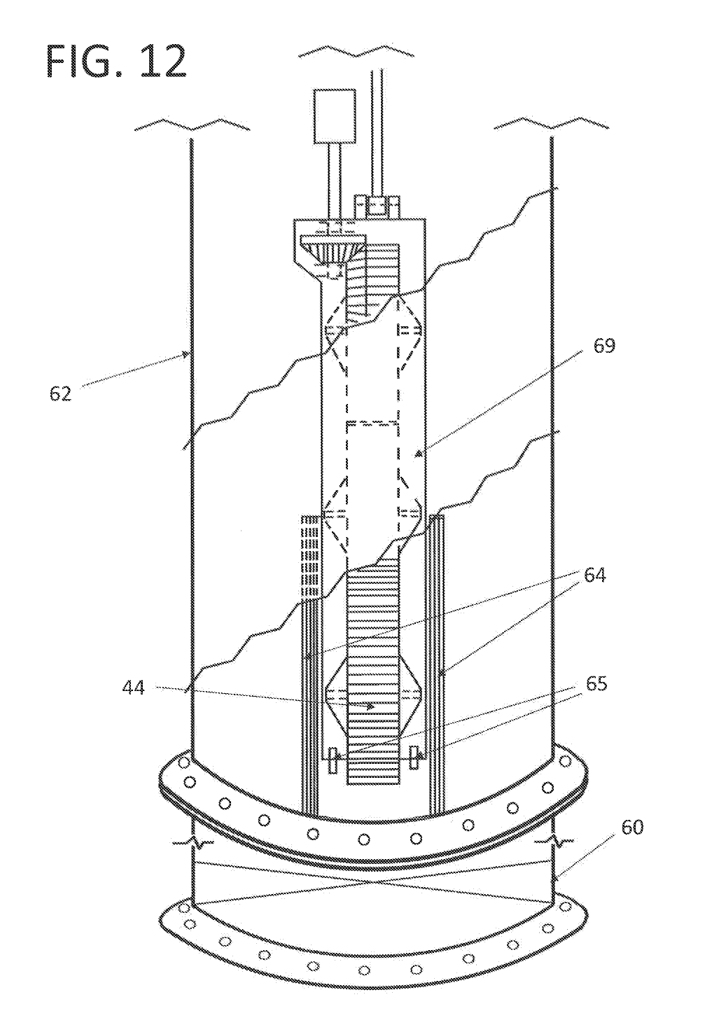

Referring to FIG. 12, an access valve 60 (block valve) is now installed on the top flange 56 (in the open position). Access valve 60 may be any valve known in the art that allows for the valve body 50 to be sealed and through which the cutting device and control section may he used.

Referring to FIG. 12, a second half of cutting assembly 69 is lowered into position (protruding the required amount to reach through access valve 60 and snap into place in the bottom section of the drive assembly). Second half of cutting assembly 69 attaches to the first half of cutting assembly 45 shown in FIG. 5. Guides 64 are provided to insure the two sections line up and “spring-loaded” latches 65 snap into place to connect them. This also engages the drive gear 44 in the top assembly with the driven gear 42 in the bottom assembly.

Referring to FIG. 12, cutting tower 62 is now lowered and bolted onto the flange 56 of the block valve. Cutting tower 62 is now filled with product from the pipeline (as shown on a stopple installation) and any trapped air bled off.

Referring to FIG. 2 through FIG. 5, cutting wheel 20 is engaged and the section of pipeline is severed.

Referring to FIG. 12, the drive assembly 45 and 69 is retracted into the cutting tower 62, pulling the cutting wheel 20 and severed section of pipeline 10 inside with it. The block valve 60 is closed and the cutting tower 62 is drained and removed.

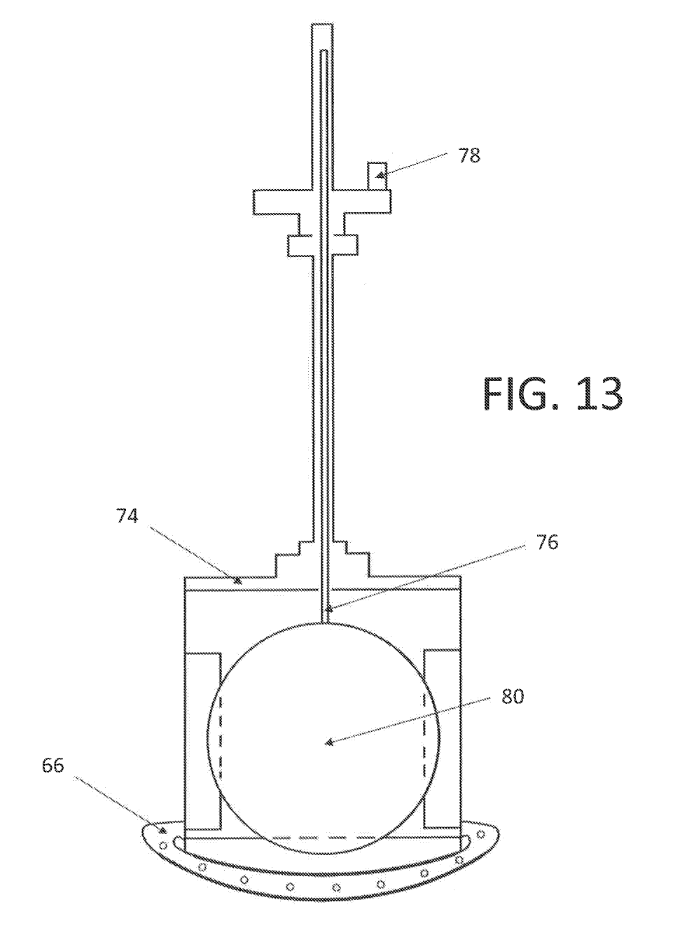

Referring to FIG. 13, the control section 74 of the EFRD valve is installed on the access valve 60. Preferably, control section 74 has a converter plate in the form of a bottom flange 66 such that the configuration of the opening is changed from round to rectangular to accommodate the control section 74. The assembly 74 is filled with pipeline product and any trapped air bled off. The access valve 60 is now opened and the EFRD gate assembly 76 is lowered through the access valve 60 and into the ready position to complete the installation. The block valve 60 remains as part of the assembly so cannot have a protruding valve stem. The EFRD valve is now ready for coating and commissioning.

Referring to FIG. 13, when an event occurs such that a user wants to dose the EFRD valve, it may be activated using, for example, a controller, or a manual activation of the EFRD gate assembly 76. A motor 78 lowers the gate valve 80 the rest of the way through the access valve 60 from the ready position to a blocking position in the pipeline. Gate valve 80 is seated between face plates 14 and 18 with the cut edge of the pipeline 10 flush with the surface of the face plates 14 and 18. This forms a seal in the pipeline 10 and the flow of fluid through the pipeline is stopped.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements,

The illustrated embodiments have been set forth only as examples and should not be taken as a purposive interpretation of the claims.

What is claimed is:

1. A method of installing an Emergency Flow Restrictor Device (EFRD) on a pipeline, comprising:
providing a first face plate having two or more segments that, when assembled, circumscribe the pipeline and providing a second face plate having two or more segments that, when assembled, circumscribe the pipeline;
assembling and welding the first face plate in place encircling the pipeline and the second face plate encircling the pipeline, in face to face relation to the first face plate;
assembling a circular cutting wheel around the pipeline between the first face plate and the second face plate;
providing a valve body having two or more segments that, when assembled, enclose the pipeline, the first face plate, the second face plate and the cutting wheel, the valve body having an access opening;
assembling and welding the valve body in place around the pipeline, the first face plate, the second face plate and the cutting wheel, the valve body being capable of containing fluids at pipeline pressures;
installing an access valve on the access opening, the access valve having an open position and a closed position, objects can be passed through the access valve when in the open position;
securing a cutting tower to the access valve, moving the access valve to the open position and lowering a drive linkage from the cutting tower through the access valve to engage the cutting wheel;
driving the cutting wheel, by means of the drive linkage, to sever a section of the pipeline between the first face plate and the second face plate;
retracting the drive linkage into the cutting tower, pulling the cutting wheel and severed section of pipeline inside of the cutting tower;
closing the access valve to enable the cutting tower to be removed;
installing a control section for the EFRD, with a control linkage for controlling a valve gate member, in place on the access valve, the control section comprising a converter flange from round to rectangular; and
moving the access valve to the open position and lowering the valve gate member for the EFRD through the access valve into position to close the pipeline when/if required.
